(19) United States
(12) Patent Application Publication
(10) Pub. No.: US 2003/0201703 A1
(43) Pub. Date: Oct. 30, 2003

(54) High pressure discharge lamp, lamp with reflecting mirror and image projecting device

(76) Inventors: Makoto Horiuchi, Nara (JP); Tsuyoshi Ichibakase, Osaka (JP); Tomoyuki Seki, Osaka (JP)

Correspondence Address: HARNESS, DICKEY & PIERCE, P.L.C., P.O. BOX 828, BLOOMFIELD HILLS, MI, 48303, US

(21) Appl. No.: 10/423,581

(22) Filed: Apr. 25, 2003

(30) Foreign Application Priority Data
Apr. 30, 2002 (JP) 2002-128604

(51) Int. Cl. H01J 5/16

(52) U.S. Cl. 313/113

(57) ABSTRACT

A high pressure discharge lamp includes a luminous tube enclosing a luminous material in which a pair of electrodes are opposed; and a pair of sealing portion for sealing metal foils electrically connected to the pair of electrodes, respectively. External leads are connected to the metal foils on the side opposite to the luminous tube side. At least one of the external leads extends outward from the end face of the sealing portion. A cap portion for covering the external lead is provided in a base portion of the external lead exposed from the end face of the sealing portion.

### BACKGROUND OF THE INVENTION

The present invention relates to a lamp unit including a high pressure discharge lamp and a reflecting mirror. In particular, the present invention relates to a lamp with a reflecting mirror (or a lamp unit) used as a light source for a liquid crystal projector or an image projecting apparatus such as a digital micromirror device (DMD) projector.

Liquid crystal projector apparatuses are known as means for magnifying and projecting images of characters, graphics and the like to display them. In addition, digital light processing (DLP) projectors using digital micro-devices are being spread. Since such image projecting apparatuses require a predetermined optical output, high-pressure mercury lamps with high brightness are, in general, used widely as light sources. The lamp of this kind is generally used in a combination with a reflecting mirror.

FIG. 14 schematically shows a cross-sectional structure of a conventional high pressure mercury lamp 150. The high pressure mercury lamp 150 shown in FIG. 14 has a substantially spherical luminous tube 100 made of quartz glass and sealing portions 101a and 101b extending from the luminous tube 100.

There is a discharge space in the luminous tube 100, and electrodes 102 made of tungsten are opposed therein. The electrode 102 is connected to one end of molybdenum foil 103 by welding, and an external lead 104 made of molybdenum is connected to the other end of the molybdenum foil 103 by welding. The electrodes 102 whose one ends are projected to the luminous tube 100, the molybdenum foils 103 and the external leads 104 constitute an electrode assembly, and are sealed with the sealing portions 101a and 101b. The electrode 102 is constituted by an electrode rod made of tungsten and a coil (not shown) made of tungsten that is wound around the head portion of the electrode rod in the vicinity of the end portion that is projected to the luminous tube 100. Although not shown in FIG. 14, mercury, a small amount of rare gas and a small amount of halogen, if necessary, are enclosed in the luminous tube 100.

FIG. 15 schematically shows the cross-sectional structure of a conventional high pressure mercury lamp 5000 with a reflecting mirror using the conventional high pressure mercury lamp 150 shown in FIG. 14.

The high pressure mercury lamp 5000 with a reflecting mirror includes the high pressure mercury lamp 150 and a reflecting mirror 200. The reflecting mirror 200 is made of a heat resistant glass whose inner face is partially parabolic, and a small hole 203 through which a metal wire 204 is passed is provided in a portion of the reflecting mirror 200. A fixture 202 made of stainless steel is attached to the outer face of the reflecting mirror 200. The conductive metal wire 204 whose one end is electrically connected to the external lead of the lamp 150 is electrically connected to the fixture 202 through the small hole 203 penetrating the reflecting mirror 200.

The lamp 150 is fixed to the reflecting mirror 200, as shown in FIG. 15. Specifically, the lamp 150 is fixed to the reflecting mirror 200 such that as much light as possible of the light emitted from the lamp 150 exits from the opening portion while being parallel to a virtual rotation axis (also referred to as an “optical axis”) of the reflecting mirror 200. More specifically, the lamp 150 is fixed to the reflecting mirror 200 in such a manner that a first sealing portion 101a of the lamp 150 is inserted into a neck portion 206 of the reflecting mirror 200 and the sealing portion 101a is fixed to the neck portion 206 with a heat resistant cement 205. As a specific size of the reflecting mirror 200, the diameter Dm of the opening portion is, for example, about 45 mm.

There is a great demand for portability with respect to recent projectors, and for this reason, development and commercialization of as compact as A5 size or B5 size and thin projectors similar to note-type personal computers in the size are in demand. Under these circumstances, regarding the high pressure mercury lamp with a reflecting mirror, a more compact mirror such as a reflecting mirror having a diameter of the opening portion of 45 mm or less has been used. In addition, regarding the type of the reflecting mirror, an ellipsoidal mirror type having a short focal distance in which emitted light converges on one point (focal point) has come to be used, instead of the type of parabolic mirrors emitting parallel light. This is due to the fact that this type has a shorter optical path in the projector, and thus can contribute the compactness of the projector more.

FIG. 16 schematically shows the cross-sectional structure of a high pressure mercury lamp 6000 with a reflecting mirror in which an ellipsoidal reflecting mirror 300 and the conventional high pressure mercury lamp 150 are combined. The reflecting mirror 300 is a reflecting mirror made of heat resistant glass whose inner face is partially ellipsoidal. F1 and F2 in FIG. 16 are focal points.

Similarly to the structure shown in FIG. 15, a fixture 302 made of stainless steel is attached to the outer face of the reflecting mirror 300 shown in FIG. 16. A conductive metal wire 204 whose one end is electrically connected to an external lead of the lamp 150 is electrically connected to the fixture 302. Furthermore, the lamp 150 is fixed to the reflecting mirror 300 in such a manner that as much light as possible of the light emitted from the lamp 150 is concentrated on the focal point (F2) of the reflecting mirror 300, as shown in FIG. 16. More specifically, the lamp 150 is fixed to the reflecting mirror 300 in such a manner that a first sealing portion 101a of the lamp 150 is inserted into a neck portion 306 of the reflecting mirror 300 and the sealing portion 101a is fixed to the neck portion 306 with a heat resistant cement 205.

In recent years, the rated power (wattage) of a high pressure mercury lamp as a light source for a projector tends to increase for the purpose of improving the performance of a projector, and the wattage of conventional lamps was 100 W to 120 W, but the wattage of recent lamps tends to be 150 W to 200 W. Even the conventional wattage of 100 W to 120 W can be said as a high wattage, but with a high pressure mercury lamp of 150 W to 200 W, an even higher load is applied to the lamp. However, at present, even for the high pressure mercury lamp of 150 W to 200 W, the lamp is still designed based on the empirical knowledge on the lamp of 100 W to 120 W.

In these circumstances, the present inventors made experiments in which a high pressure mercury lamp of 150 W or more is incorporated into a digital micromirror device (DMD) projector, and the lamp is operated. Then, a phenomenon that was impossible to occur in the conventional lamp of 100 W to 120 W occurred. That is, a portion of the external lead 104 was burned and cut apart. More specifically, a base portion 104e of the external lead 104 exposed from the end face of the sealing portion 101b in the high pressure mercury lamp shown in FIG. 16 was burned and cut apart. FIG. 17 is a trace diagram of a photograph showing this phenomenon.

FIG. 17 indicates that the base portion 104e of the external lead 104 is lost. In general, it is believed that a welded portion 104w (more specifically, the connection portion of the leads 104 and 204) is weaker than other portions (e.g., the external lead 104), but the lamp stops operating not because the welded portion 104 is broken, but rather because the base portion 104e of the external lead 104 is lost. In FIG. 17, the base portion 104e of the external lead 104 is lost, so that in the welded portion 104w, a nickel sleeve interposed between the external lead 104 and the metal wire 204 and welded with them is left supported by the metal wire 204 as if it was suspended in the air.

### SUMMARY OF THE INVENTION

The present invention is carried out in view of the above aspects, and it is a main object of the present invention to provide a high pressure discharge lamp that can be operated stably, even if it is a high wattage (e.g., 150 W or more) lamp.

A first high pressure discharge lamp of the present invention includes a luminous tube enclosing a luminous material in which a pair of electrodes are opposed; and a pair of sealing portions for sealing metal foils electrically connected to the pair of electrodes, respectively. External leads are connected to the metal foils on a side opposite to the luminous tube side. At least one of the external leads extends outward from an end face of the sealing portion, a cap portion for covering the external lead is provided in a base portion of the external lead exposed from the end face of the sealing portion. The external lead is joined to an outward-drawn lead wire electrically connected to an external circuit by plastic flow of the cap portion, using the cap portion as a caulking member.

A second high pressure discharge lamp of the present invention includes a luminous tube enclosing a luminous material in which a pair of electrodes are opposed; and a pair of sealing portion for sealing metal foils electrically connected to the pair of electrodes, respectively. External leads are connected to the metal foils on a side opposite to the luminous tube side. At least one of the external leads extends outward from an end face of the sealing portion. A cap portion for covering the external lead in a portion extending from an end face of the metal foil in the sealing portion, in addition to a base portion of the external lead exposed from the end face of the sealing portion, is provided in the external lead.

In one embodiment, the external lead is joined to an outward-drawn lead wire electrically connected to an external circuit by plastic flow of the cap portion, using the cap portion as a caulking member.

In one embodiment of the high pressure discharge lamp, mercury is enclosed in an amount of 150 mg/cm³ or more as the luminous material.

A lamp with a reflecting mirror of the present invention includes a high pressure discharge lamp and a reflecting mirror for reflecting light emitted from the high pressure discharge lamp. The high pressure discharge lamp is the above-described high pressure discharge lamp. The reflecting mirror has a reflecting surface that is substantially ellipsoidal, and the high pressure discharge lamp is a high pressure discharge lamp to which a rated power of 150 W or more is supplied.

Another lamp with a reflecting mirror of the present invention includes a double end type high pressure mercury lamp including a luminous tube enclosing a luminous material inside and a first and a second sealing portion extending from opposite ends of the luminous tube; and a reflecting mirror for reflecting light emitted from the high pressure mercury lamp. The reflecting mirror includes a wide opening provided on a side in a light emission direction, and a narrow opening for fixing the high pressure mercury lamp. The first sealing portion of the high pressure mercury lamp is fixed in a vicinity of the narrow opening of the reflecting mirror. The second sealing portion of the high pressure mercury lamp is disposed on a side of the wide opening of the reflecting mirror. The second sealing portion has a cap portion for covering at least a base portion of a external lead extending outward from the second sealing portion and being exposed. The cap portion serves as a caulking member and is used to join the external lead and an outward-drawn lead wire by caulking. The external lead and the outward-drawn lead wire electrically connected to an external circuit are electrically connected each other, using the cap portion.

In one embodiment, the maximum diameter of a reflecting surface of the reflecting mirror is 45 mm or less, and the reflecting surface of the reflecting mirror is substantially ellipsoidal.

An image projecting apparatus of the present invention includes the above-described lamp with a reflecting mirror and an optical system using the above-described lamp with a reflecting mirror as a light source.

In one embodiment, the optical system has a digital micromirror device, and the light source is of a type that converges outgoing light onto a focal point.

### BRIEF DESCRIPTION OF THE DRAWINGS

FIG. 1 is a cross-sectional view schematically showing the structure of a lamp 1000 with a reflecting mirror according to Embodiment 1 of the present invention.

FIG. 2 is a cross-sectional view schematically showing the structure of a high pressure discharge lamp 1100 according to Embodiment 1 of the present invention.

FIG. 3 is a cross-sectional view schematically showing the structure of a reflecting mirror 300.

FIGS. 4A to 4C are diagrams illustrating the manner in which the diameter of the external lead 104e is reduced.

FIG. 5 is a view schematically showing the structure of a lamp 1000 with a reflecting mirror and an optical system 90.

FIG. 6 is a cross-sectional view schematically showing the structure of a lamp 2000 with a reflecting mirror of Embodiment 2 of the present invention.

FIG. 7 is a cross-sectional view of an enlarged relevant portion of a front cap 10.

FIG. 8A is a cross-sectional view schematically showing the structure of a high pressure discharge lamp 1300 of Embodiment 3 of the present invention, and FIG. 8B is a perspective view schematically showing the structure of a front cap 11.

FIG. 9A is a cross-sectional view schematically showing the structure of a high pressure discharge lamp 1400′ of a variation of Embodiment 3, and FIG. 9B is a perspective view schematically showing the structure of a front cap 11.

FIG. 10 is a cross-sectional view schematically showing the structure of a lamp 3000 with a reflecting mirror.

FIG. 11 is a cross-sectional view schematically showing the structure of a high pressure discharge lamp 1500.

FIG. 12 is a perspective view schematically showing the structure of a front cap 12.

FIGS. 13A to 13C are cross-sectional views for illustrating a method for producing the high pressure discharge lamp 1500.

FIG. 14 is a cross-sectional view schematically showing the structure of a conventional high pressure mercury lamp 150.

FIG. 15 is a cross-sectional view schematically showing the structure of a conventional high pressure mercury lamp 5000 with a reflecting mirror.

FIG. 16 is a cross-sectional view schematically showing the structure of a conventional high pressure mercury lamp 6000 with a reflecting mirror.

FIG. 17 is a trace diagram showing a phenomenon in which the base portion 104e of the external lead 104 is burned and cut apart.

FIG. 18 is an enlarged diagram showing the vicinity of the welded portion 104w.

### DETAILED DESCRIPTION OF THE INVENTION

Hereinafter, embodiments of the present invention will be described with reference of the accompanying drawings. In the following drawings, for simplification of description, the elements having substantially the same function bear the same reference numeral. However, the present invention is not limited to the following examples.

Embodiment 1

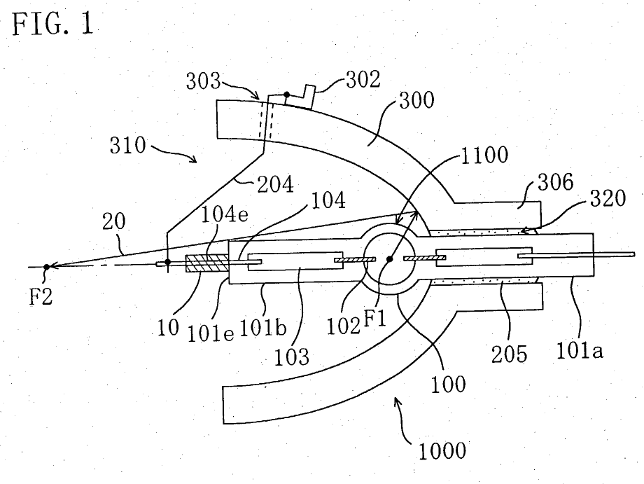

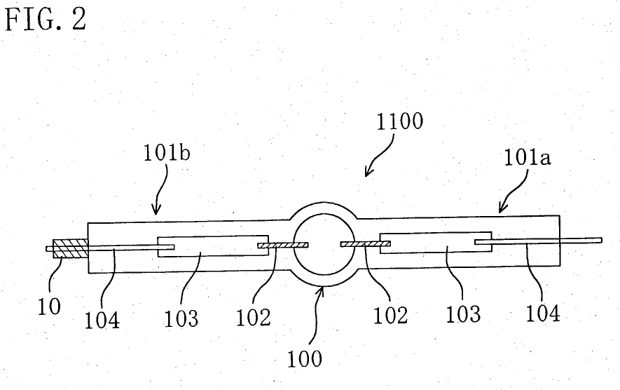

Embodiment 1 of the present invention will be described with reference to FIGS. 1 and 2. FIG. 1 schematically shows the structure of a high pressure discharge lamp 1100 of this embodiment and a lamp 1000 with a reflecting mirror including the lamp 1100. FIG. 2 schematically shows the structure of the lamp 1100 alone.

The high pressure discharge lamp 1100 of this embodiment has a luminous tube (bulb) 100 and a pair of sealing portions 101a and 101b coupled to the luminous tube 100. There is a discharge space in the luminous tube 100 in which a luminous material is enclosed, and in the discharge space, a pair of electrodes 102 are opposed. The luminous tube 100 is made of quartz glass, and is substantially spherical. In this embodiment, mercury is enclosed in an amount of 150 mg/cm³ or more based on the volume of the discharge space as a luminous material, and the lamp 1100 of this embodiment is classified generally to so-called superhigh pressure mercury lamp.

The sealing portions 101a and 101b seal the metal foils 103 electrically connected to the electrodes 102. The external leads 104 are connected to the metal foils 103 on the opposite side of the luminous tube 100. At least one of the external leads 104 extends outward from the end face of the sealing portions (101a, 101b) and the external lead 104 is connected to a ballast circuit (not shown) via another member (e.g., 204). A rated power of, for example, 150 W or more is supplied to the high pressure discharge lamp 1100. In other words, the high pressure discharge lamp 1100 of this embodiment is a lamp of 150 W or more (150 W to 200 W or more).

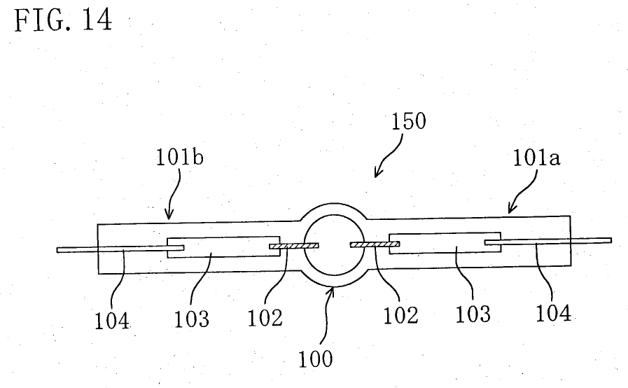

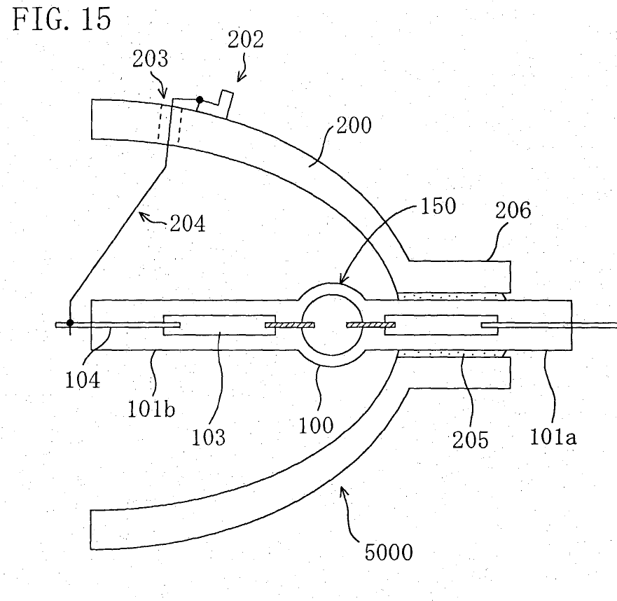

In this embodiment, in the base portion (104e) exposed from the end face 101e of the sealing portion 101b of the external lead 104, a cap portion (hereinafter, referred to as a “front cap”) 10 for covering the external lead (104e) in that portion is provided. This front cap 10 allows the high pressure discharge lamp 1100 to be operated stably even if the wattage is high (e.g., 150 W or more). The front cap 10 is, for example, cylindrical, and for example, the inner diameter is 1.0 to 3.0 mm, the outer diameter is 1.5 to 3.0 mm, and the length is 2.0 to 5.0 mm. Other elements are the same as those shown in FIGS. 14 to 16, so that they are denoted by the same reference numeral, and description thereof will be omitted or simplified.

When the high pressure discharge lamp 1100 is utilized as a light source of an image projecting apparatus, it is combined with a reflecting mirror 300 for reflecting light emitted from the high pressure discharge lamp to configure a lamp 1000 with a reflecting mirror, as shown in FIG. 1. The reflecting mirror 300 in this embodiment has a reflecting face that is substantially ellipsoidal.

The structure of the lamp 1000 with a reflecting mirror will be described in detail below. The lamp 1000 with a reflecting mirror includes a double end type high pressure mercury lamp 1100 having a luminous tube 100 and a first and a second sealing portion (101a, 101b) extending from both ends of the luminous tube 100, and the reflecting mirror 300. The reflecting mirror 300 includes a wide opening 310 provided on the side from which light goes out and a narrow opening 320 at which the high pressure mercury lamp 1100 is fixed. As shown in FIG. 1, the first sealing portion 101a of the high pressure mercury lamp 1100 is fixed in the vicinity of the narrow opening 320 of the reflecting mirror 300, and the second sealing portion 101b of the high pressure mercury lamp 1100 is disposed on side of the wide opening 310 of the reflecting mirror 300. The front cap (cap portion) 10 for covering at least the base portion 104e of the external lead 104 that extends outward from the second sealing portion 101b and is exposed is provided in the second sealing portion 101b in such a manner that the front cap 10 is in contact with the end face 101e of the second sealing portion 101b. Herein, the base portion 104e of the external lead 104 refers to the portion exposed from the end face 101e of the sealing portion 101b, typically, the portion in a distance of about 1.0 to 5.0 mm from the end face 101e.

In the structure shown in FIG. 1, the external lead 104 in the portion exposed from the front cap 10 is connected to the outward-drawn lead wire 204. The outward-drawn lead wire 204 is made of, for example, a Ni—Mn alloy. Since the two members (104 and 204) cannot be directly welded because of the properties of the constituent materials, the external lead 104 and the outward-drawn lead wire 204 are welded via, for example, a nickel sleeve. In this embodiment, the front cap 10 also can be used as a member for welding. That is, it is possible to weld the external lead 104 and the outward-drawn lead wire 204 via the front cap 10. In this case, the external lead 104 and the front cap 10 are welded each other, and the front cap 10 and the outward-drawn lead wire 204 are welded each other. If the front cap 10 is used as a member for welding, the number of members can be reduced, which provides an advantage in terms of the production process and cost.

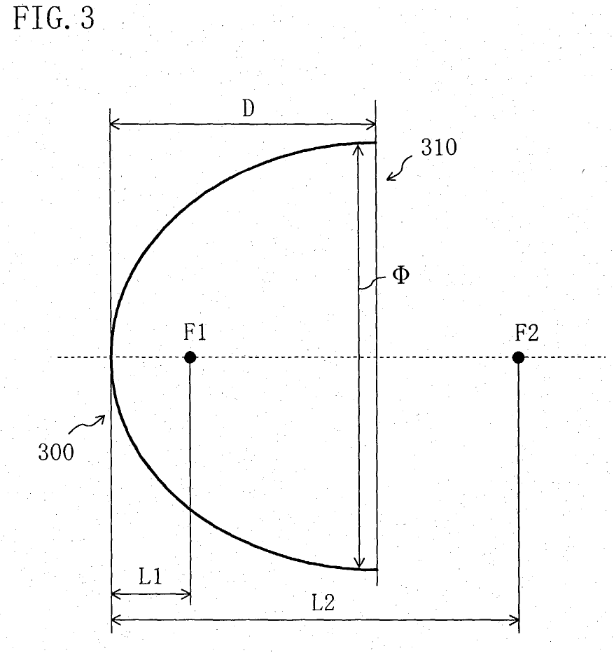

The size of the reflecting mirror 300 of this embodiment and its focal point are those shown in FIG. 3, for example. The diameter φ of the wide opening 310 is about 45 mm, and the depth D of the reflecting mirror 300 is about 33 mm. The distance from the deepest portion of the reflecting mirror 300 to the focal points F1 and F2 are about 8 mm and about 64 mm, respectively. The volume of the reflecting mirror 300 is about 40000 mm³, that is, about 40 cm³. The above-listed sizes of the reflecting mirror 300 are the same as those that the inventors of the present invention used for experiments to operate a lamp incorporated in a projector using a digital micromirror device (DMD).

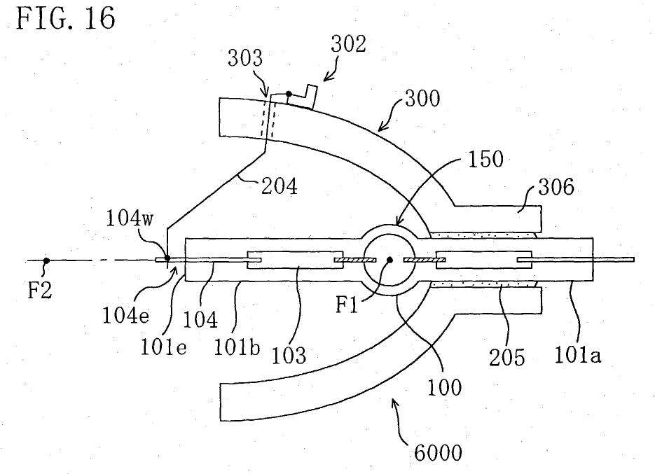

In a lamp 6000 with a reflecting mirror including a lamp 150 as shown in FIG. 16, the reason why the portion (104e) of the external lead 104 is burned and cut apart is not clear at present. However, the following can be inferred.

First, since the external lead 104 is made of molybdenum, when the temperature thereof reaches about 600° C., it is evaporated (sublimated). In the case of a lamp of 100 W to 120 W, it is inferred that the temperature of the external lead 104 does not increase to such a temperature, whereas in the lamp of 150 W to 200 W, the temperature increases to such a temperature. In particular, in the case of a projector using a DMD, a lamp having a higher wattage lamp tends to be used, so that it is possible that the temperature of the external lead 104 may reach 600° C. or more, which was not contemplated in the past.

When such a temperature is reached, it seems that local cooling with a cooling fan or the like is not sufficient. That is to say, even if a portion of the lamp 6000 with a reflecting mirror is cooled, the lamp 6000 with a reflecting mirror cannot be cooled so as to prevent effectively heating due to light irradiated to the external lead 104, although the lamp 6000 with a reflecting mirror can be cooled locally. In other words, in the lamps of 150 W to 200 W, the energy density in the external lead 104 (especially 104e) becomes too high, and the theory for heating design of lamps of 100 W to 120 W cannot apply to the case of the lamps of 150 W to 200 W.

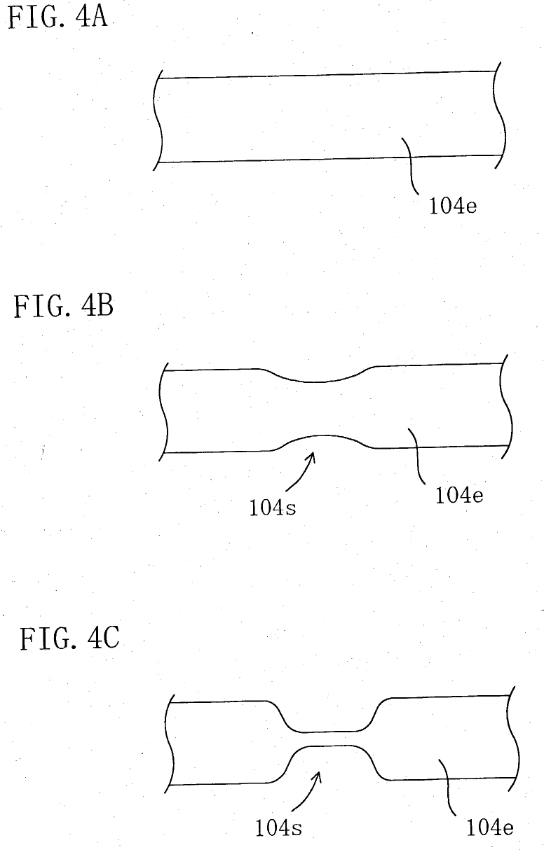

When the outgoing light which is the light output from the lamp falls on the external lead 104 (especially 104e), the molybdenum in that portion can sublimate. Then, the diameter of the external lead 104 is narrowed, and the resistance is increased in that portion, so that the temperature in that portion is increased even further. As a result, the diameter of that portion is increasingly reduced. Eventually, that portion is lost. FIGS. 4A to 4C show the manner in which this occurs.

First, the exposed portion 104e of the external lead 104 is in the state shown in FIG. 4A, but a portion sublimates, and a portion 104s having a reduced diameter is generated, as shown in FIG. 4B. Since the portion 104s has a smaller diameter than that of other portions, the resistance is higher. Therefore, the amount of generated heat is larger in this portion than other portions. This heat generation reduces the diameter of the portion 104s more and more, as shown in FIG. 4C, and eventually that portion disappears.

The generation of the portion 104s having a reduced diameter as shown in FIG. 4B seems to be not only due to the sublimation of the molybdenum, but also an influence of so-called creep. That is, as a result of expansion and contraction being repeated when the lamp is turned on and off, the portion 104s having a reduced diameter can be generated. Alternatively, it seems that the portion 104s having a reduced diameter also can be generated by a stress between a portion that is irradiated with much light and a portion that is irradiated with little light. In particular, when cooling means (e.g., a cooling fan, a heat sink) is provided, the difference in the temperature between a portion having a high temperature and a portion having a low temperature becomes large, so that the creep phenomenon generates the portion 104s having a reduced diameter, and thereafter the diameter of the portion 104s whose resistance has become high is reduced further and then that portion is lost.

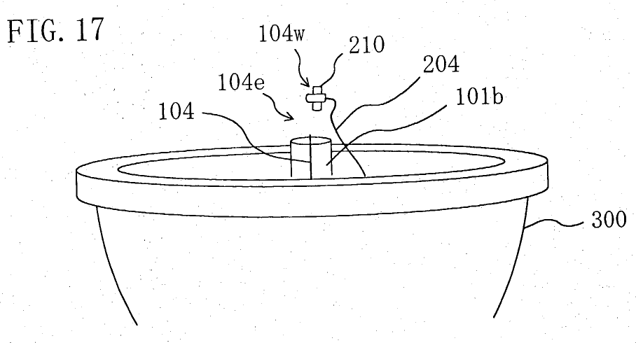

As shown in FIG. 17, considering that breakage of the external lead 104e proceeds more than that of the welding portion 104, which is regarded as being comparatively fragile, the breakage may be due to the creep phenomenon or synergism of the creep phenomenon and irradiation of light, rather than simply the sublimation phenomenon by irradiation of light. If the creep phenomenon participates in it, in the structure shown in FIG. 16, it is not effective to simply attach cement to the end face 101e of the sealing portion 101b so as to cover the external lead 104 (in particular, the base portion 104e) in order to prevent the external lead 104e from being broken. This is because although this approach may allow light irradiated to the external lead 104e to be shielded by the cement, the creep phenomenon still can cause the breakage.

In this embodiment, the base portion 104e of the external lead 104 extending from the end face of the sealing portion 101b and being exposed is covered with the front cap 10, so that an increase more than necessary in the temperature of the portion 104e of the external lead 104 due to the outgoing light 20 from the lamp 100 converging onto the focal point F2 can be prevented. Furthermore, the front cap 10 is in contact with the base portion 104e of the external lead 104, so that the heat capacity of the portion that tends to disappear (104e) can be increased. This makes it possible that breakage due to the creep phenomenon hardly occurs. The front cap 10 is made of, for example, a metal, and preferably a heat resistant material (e.g., brass). The front cap 10 of this embodiment has a cylindrical shape and the inner diameter thereof is substantially equal to the outer diameter of the external lead 104.

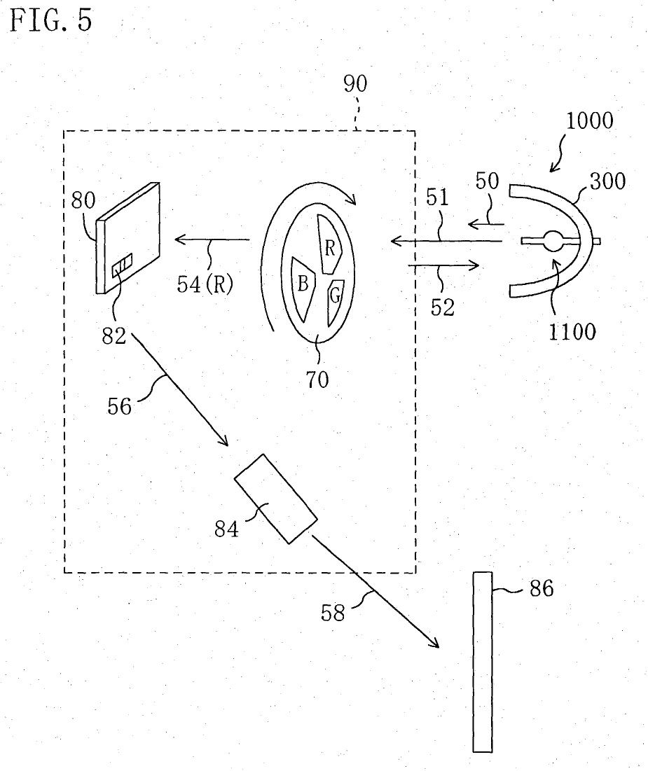

The lamp 1000 with a reflecting mirror including the front cap 10 of this embodiment is particularly suitable to use as a light source (lamp unit) for a DLP projector as shown in FIG. 5. This is because in the case of a DLP projector, there is light 52 that is emitted from the lamp 1000 with a reflecting mirror as light 51 and is incident again to the reflecting mirror 300 of the lamp 1000 with a reflecting mirror. The presence of the light 52 that came back causes a discrepancy in the heat design based on the examination of the lamp alone, and the temperature of the lamp 1000 with a reflecting mirror is increased more than designed, so that the lamp 1100 cannot be operated. Furthermore, how much the light 52 comes back is not known until the lamp 1000 with a reflecting mirror is combined with an optical system 90 of a DLP projector. It is not realistic to perform the heat design of the lamp 1000 with a reflecting mirror, corresponding to the optical system 90 in accordance with the type of the DLP projector.

In the case of this embodiment, even if the lamp 1000 with a reflecting mirror is used as a light source for the DLP projector, the lamp includes the front cap 10, so that the influence of both the outgoing light 51 and the light 52 that comes back can be reduced or suppressed. Therefore, heat design does not have to be performed in accordance with the type of the optical system 90 of the DLP projector every time, which is a large advantage. Hereinafter, the structure and the operation of the DLP projector into which the lamp 1000 with a reflecting mirror of this embodiment is incorporated will be briefly described.

FIG. 5 schematically shows the structure of a single panel DLP projector, and the DLP projector shown in FIG. 5 includes a lamp 1000 with a reflecting mirror, and an optical system 90. The optical system 90 includes a color wheel 70 arranged forward in the direction 50 to which the light is emitted from the lamp 1000 with a reflecting mirror and a DMD panel 80 (constituted by a plurality of DMDs 82) for reflecting light 54 transmitted through the color wheel 70, and a projecting lens 84 for converting light 56 projected from the DMD panel 80 to a projected light 58 and projecting it on a screen 86.

The light 51 emitted from the lamp 1000 with a reflecting mirror passes through one color (e.g., R) of the three primary colors (R, G, and B) of the color wheel 70 that rotates at 120 rotations per second and then projected to the DMD panel 80 via a focus lens (not shown) and then projected on the screen 86. In the case of a single panel DLP projector, the DMDs 82 of the DMD panel 80 are turned on and off repeatedly at a speed of several thousands to several ten thousands per second so as to instantly superimpose colors of R, G and B that have passed through the color wheel 70 so that one picture is formed on the screen 86 by utilizing the afterimage effect of human eyes.

The light that did not pass through the color wheel 70 of the outgoing light 51 from the lamp 1000 with a reflecting mirror is incident again to the reflecting mirror 300 of the lamp 1000 with a reflecting mirror as the reflected light 52. However, as shown in FIG. 1, the base portion 104e of the external lead 104 is covered with the front cap 10, so that even if the reflected light 52 is incident to the reflecting mirror 300, the base portion 104e of the external lead 104 can be protected. As described above, the front cap 10 also protects it from the outgoing light 51. Not only the influence of the light 52 from the optical system 90 of a single panel DLP projector as described in this embodiment, but also the influences of light incident to the reflecting mirror 300 from an optical system of a three-panel DLP projector employing three DMD panels 80 or light incident to the reflecting mirror 300 from an optical system of a liquid crystal projector can be reduced or suppressed by the front cap 10.

The conditions of the structure of this embodiments are as follows, for example. The luminous tube 100 of the lamp 1100 is substantially spherical and is made of quartz glass. In order to realize a high pressure mercury lamp (in particular, a superhigh pressure mercury lamp) having excellent characteristics such as a long lifetime, it is preferable to use high purity quartz glass having a low level of alkali metal impurities (e.g., the mass of each type of alkali metal is 1 ppm or less) as the quartz glass constituting the luminous tube 100. It is of course possible to use quartz glass having a regular level of alkali metal impurities. The outer diameter of the luminous tube 100 is, for example, about 5 mm to 20 mm, and the glass thickness of the luminous tube 100 is, for example, about 1 mm to 5 mm. The volume of the discharge space in the luminous tube 100 is, for example, about 0.01 to 1 ml (0.01 to 1 cm³). In this embodiment, a luminous tube 100 having an outer diameter of about 9 mm, an inner diameter of about 4 mm and a volume of the discharge space of about 0.06 ml is used.

A pair of electrodes (electrode rods) 102 are opposed to each other in the luminous tube 100. The heads of the electrodes 102 are arranged in the luminous tube 100 with a distance (arc length) D of about 0.2 to 5 mm (e.g., 0.6 to 1.0 mm), and each of the pair of electrodes 102 is made of tungsten (W). It is preferable to wind a coil (e.g., a coil made of tungsten) around the heads of the electrodes 102 for the purpose of reducing the temperature of the electrode heads during lamp operation.

In the luminous tube 100, mercury is enclosed as a luminous material. When a superhigh pressure mercury lamp is operated as the lamp 1100, for example, mercury in an amount of about 150 mg/cm³ or more (150 to 200 mg/cm³ or more), a rare gas at 5 to 30 kPa (e.g., argon), and a small amount of halogen, if necessary, are enclosed in the luminous tube 100.

The halogen enclosed in the luminous tube 100 serves for halogen cycle that returns W (tungsten) that has evaporated from the electrodes 102 during operation to the electrodes 102 again, and is, for example, bromine. The halogen to be enclosed can be in the form of a single substance or in the form of a halogen precursor (form of a compound). In this embodiment, halogen in the form of CH₂Br₂ is introduced into the luminous tube 100. The amount of CH₂Br₂ enclosed is about 0.0017 to 0.17 mg/cm³, and this corresponds to about 0.01 to 1 μmol/cm³ when this is expressed by a halogen atom density during lamp operation. The strength against pressure (operating pressure) of the lamp 1100 is 15 to 20 MPa or more. The rated power is, for example, 150 W (which corresponds to a load at the tube wall of about 130 W/cm²). The load at the tube wall is, for example, about 130 W/cm² or more, and the upper limit is not particularly set. For example, a lamp having a load at the tube wall in the range of 130 W/cm² or more to about 300 W/cm² (preferably 130 to 200 W/cm²) can be realized. In this embodiment, an influence of the creep phenomenon can be prevented by the front cap 10, so that it is possible to achieve a load at a wall tube of about 300 W/cm² or more by providing cooling means.

It is preferable that the maximum diameter of the reflecting surface of the reflecting mirror 300 is 45 mm or less, and is 40 mm or less in order to satisfy a demand for further compactness. The reflecting mirror 300 can be of an airtight structure by attaching a front glass in the wide opening portion 310 of the reflecting mirror 300. It is preferable that the inner volume of the reflecting mirror 300 is 200 cm³ or less.

According to this embodiment, the base portion 104e of the external lead 104 can be protected by the front cap 10, so that a lamp with a high wattage (e.g., 150 W or more) can be stable when it is used.

Embodiment 2

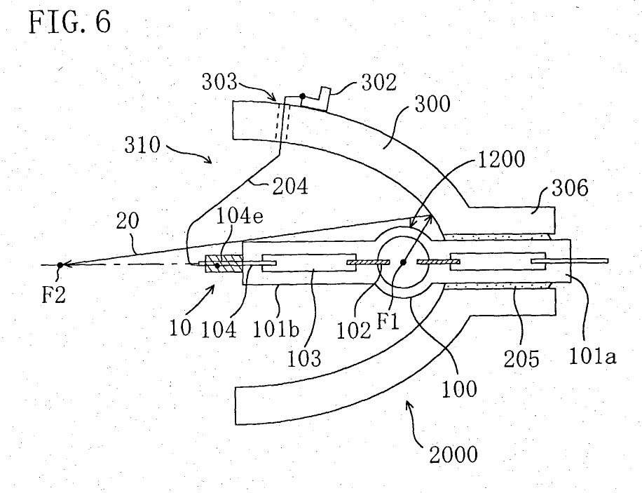

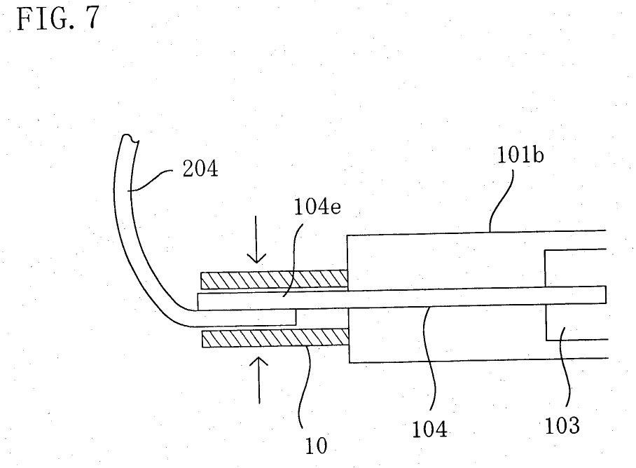

Embodiment 2 of the present invention will be described with reference to FIGS. 6 and 7. FIG. 6 shows the structures of a high pressure discharge lamp 1200 of this embodiment and a lamp 2000 with a reflecting mirror including lamp 1200.

In the lamp 2000 with a reflecting mirror of this embodiment, the external lead 104 of the sealing portion 101b is joined to the outward-drawn lead wire 204 by caulking, using the front cap 10 as a caulking member. In other words, the external lead 104 of the sealing portion 101b is joined to the outward-drawn lead wire 204 by the plastic flow of the front cap 10. The structure of Embodiment 2 is different from that of Embodiment 1 in this point. FIG. 7 schematically shows the manner in which the external lead 104 of the sealing portion 101b is caulked by the front cap 10.

The structure of Embodiment 2 is basically the same from that of Embodiment 1 in other aspects. Therefore, also in the structure of this embodiment, the front cap 10 protects the base portion 104e of the external lead 104, and the same effect as in Embodiment 1 can be obtained. For simplification of the description of this embodiment and the following embodiments, different aspects from Embodiment 1 will be primarily described and the same aspects as in Embodiment 1 will be omitted or simplified in the following description.

As shown in FIG. 6, in this embodiment, the external lead 104 is joined to the outward-drawn lead wire 204 by the plastic flow of the front cap 10, and welding is not used for this joining. More specifically, as shown in FIG. 7 with an enlarged view, the external lead 104 (104e in FIG. 7) and the outward-drawn lead wire 204 are caulked by applying a stress from the outside of the front cap 10. Thus, the two members (104 and 204) are joined not by welding, but by the plastic flow of the front cap 10, which is a caulking member. The front cap 10 is, for example, a sleeve having a cylindrical shape before the plastic deformation. In this embodiment, caulking is performed by preparing a cylindrical member having an inner diameter larger than the outer diameter of the external lead 104, and applying a stress to that member.

Molybdenum itself that constitutes the external lead 104 is a material that is hardly deformed plastically, so that it is preferable that the front cap 10 serving as a caulking member is made of a material more plastic than molybdenum. Examples of such a material include Al, Cu, and Ni. Since the portion at which the front cap 10 is positioned is where heat tends to be generated because of contact resistance of light or current of the lamp. Therefore, also in order to improve the reliability of the lamp, it is preferable that the front cap 10 is made of a material having excellent oxidation resistance (e.g., Al). In view of this point, as described above, it is also desirable that the front cap 10 is made of brass.

In this embodiment, when the outer diameter of the external lead 104 is about 0.6 mm, a cylindrical front cap (length in the longitudinal direction of about 3.0 mm) 10 made of Al having an inner diameter of about 1.2 mm (thickness of about 0.2 mm) is used. Since it is sufficient to achieve joining with plastic flow of the front cap 10, the present invention is not limited to the cylindrical member as used in this embodiment, but a U-shaped member or a double plate member can be used, for example. However, even if these members are used to constitute the front cap 10, it is necessary to protect the base portion 104e of the external lead 104 appropriately.

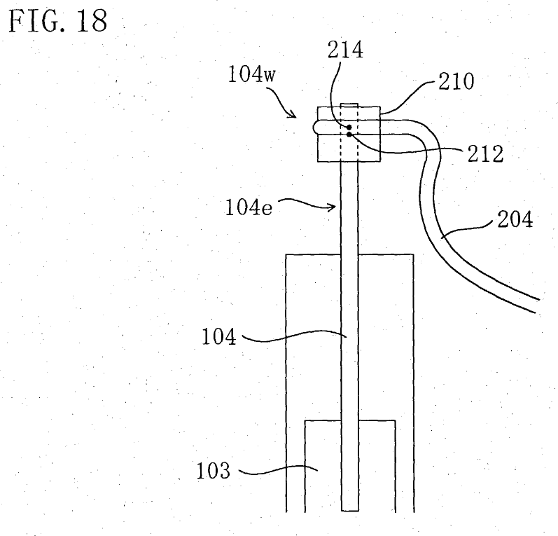

When the external lead 104 and the outward-drawn lead wire 204 are joined each other by the plastic flow of the front cap 10 as in this embodiment, the following advantages can be obtained. First, the external lead 104 and the outward-drawn lead wire 204 can be electrically connected while being in contact with each other at many points or at their faces. Therefore, the reliability of the connection between the external lead 104 and the outward-drawn lead wire 204 can be improved more than in the case where they are joined by welding. FIG. 18 shows an enlarged view of the vicinity of the welded portion 104w shown in FIG. 17. FIG. 18 shows the structure in which the base portion 104e of the external lead 104 has not disappeared yet.

As described above, it is technically difficult to join the external lead 104 and the outward-drawn lead wire 204 directly by welding, because molybdenum constituting the external lead 104 has the properties of being recrystallized at high temperature and becoming fragile. Therefore, it is necessary to weld the external lead 104 and the outward-drawn lead wire 204 at a low temperature. For this reason, as shown in FIG. 18, first, a sleeve (cylinder) 210 made of Ni is inserted so as to be in contact with the outer circumference of the connection portion of the external lead 104, and then the external lead 104 and the sleeve 210 are welded at a comparatively low temperature. Then, the sleeve 210 and the outward-drawn lead wire 204 made of a Ni—Mn alloy are welded. If welding is performed in this manner, it is possible to electrically connect the external lead 104 and the outward-drawn lead wire 204 while preventing the external lead 104 from becoming fragile.

In the structure shown in FIG. 18, a welded portion 214 of the sleeve 210 and the outward-drawn lead wire 204 is formed by spot-welding so that the contact area is small (almost a point contact). Therefore, when a stress is applied to the outward-drawn lead wire 204, the outward-drawn lead wire 204 can be detached from the welded portion 214 easily. Furthermore, since a welded portion 212 of the external lead 104 and the sleeve 210 is formed by spot welding, when a stress is applied to the sleeve 210, the sleeve 210 may be moved and detached from the welded portion. Furthermore, the welded portions 212 and 214 are almost point contacts, so that there is the problem that the contact resistance is comparatively high at these portions.

On the other hand, as shown in FIGS. 6 and 7, in the structure of this embodiment, the external lead 104 and the sleeve 210 are joined not by welding but by caulking, so that the mechanical strength in the connection portion (in the vicinity of 104e) can be higher than in the structure shown in FIG. 18. Furthermore, since the external lead 104 and the outward-drawn lead wire 204 are in contact with each other at multiple points or at their faces, the contact resistance between the external lead 104 and the outward-drawn lead wire 204 can be smaller than in the structure shown in FIG. 18. Furthermore, an increase in the temperature at the connection portion (in the vicinity of 104e) during lamp operation can be reduced, which also can improve the reliability of the lamp. According to the structure of this embodiment, since connection reliability is ensured in advance to some extent, a production process can be performed without inspecting whether or not en electrical connection is good, which is performed when they are joined by welding. As a result, the production cost can be reduced.

According to this embodiment, the base portion 104e of the external lead 104 can be protected by the front cap 10, and the external lead 104 and the outward-drawn lead wire 204 are joined by caulking with the front cap 10, so that the lamp can be operated stably even if the lamp has a high wattage (e.g., 150 W or more). In addition, the connection reliability of the external lead 104 and the sleeve 210 can be improved.

Embodiment 3

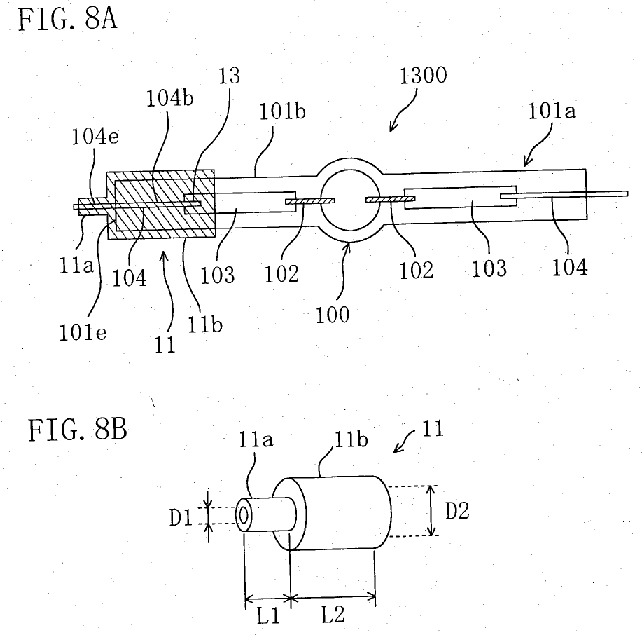

Embodiment 3 of the present invention will be described with reference to FIGS. 8A and 8B. FIG. 8A schematically shows the structure of a high pressure discharge lamp 1300 of this embodiment, and FIG. 8B schematically shows the structure of a front cap 11 of the high pressure discharge lamp 1300.

In the high pressure discharge lamp 1300 of this embodiment, the front cap (cap portion) 11 covering the outer circumference of the sealing portion 101b of the portion corresponding to the portion extending from the end face of the metal foil 103 in the sealing portion 101b is provided in the external lead 104 (in particular, 104e) and the sealing portion 101b, in addition to the base portion (104e) of the external lead 104 exposed from the end face 101e of the sealing portion 101b. That is to say, not only the base portion (104e) of the external lead 104 exposed from the end face 101e of the sealing portion 101b but also the portion (104b) of the external lead 104 that is buried in the sealing portion 101b is protected by the front cap 11.

The front cap 11 consists of a first portion 11a for protecting mainly the base portion 104e and a second portion 11b for protecting mainly the buried portion 104b, as shown in FIG. 8B. It is preferable that the second portion 11b of the front cap 11 is configured so as to cover all the way up to the outer circumference of the sealing portion 101b corresponding to the connection portion (welded portion) 13 of the metal foil 103 and the external lead 104, as shown in FIG. 8A.

It is preferable that the first portion 11a of the front cap 11 is configured such that the external lead 104 and the outward-drawn lead wire 204 are joined by caulking as in Embodiment 2. The external lead 104 may be welded to the outward-drawn lead wire 204 via the first portion 11a of the front cap 11. More specifically, the first portion 11a of the front cap 11 and the external lead 104 are joined by caulking, whereas the first portion 11a of the front cap 11 and the outward-drawn lead wire 204 can be joined by welding. Furthermore, as in Embodiment 1, the external lead 104 and the outward-drawn lead wire 204 may be joined at other portions than the front cap 11.

When joining the external lead 104 and the outward-drawn lead wire 204 both by caulking by the first portion 11a of the front cap 11, the inner diameter D1 of the first portion 11a is equal to or slightly larger than the sum of the wire diameters of the external lead 104 and the outward-drawn lead wire 204 (e.g., φ about 1 to 3 mm). When only the external lead 104 is caulked by the first portion 11a of the front cap 11, the inner diameter D1 of the first portion 11a is equal to or slightly larger than the wire diameter of the external lead 104 (e.g., φ about 0.5 to 2 mm). The inner diameter D2 of the second portion 11b depends on the outer diameter of the sealing portion 101b, for example, φ about 3 to 7 mm. The length L1 of the first portion 11a is, for example, about 2 to 7 mm, and the length L2 of the second portion 11b is, for example, about 5 to 10 mm.

In the structure of this embodiment, not only the base portion 104e of the external lead 104, but also the buried portion 104b can be protected by the front cap 11, so that further protection of the external lead 104 can be achieved. Since the connection portion (welded portion) 13 between the metal foil 103 and the external lead 104 is comparatively weak to heat, if all the portion up to that portion is protected by the second portion 11b of the front cap 11, the reliability of the lamp can be improved further.

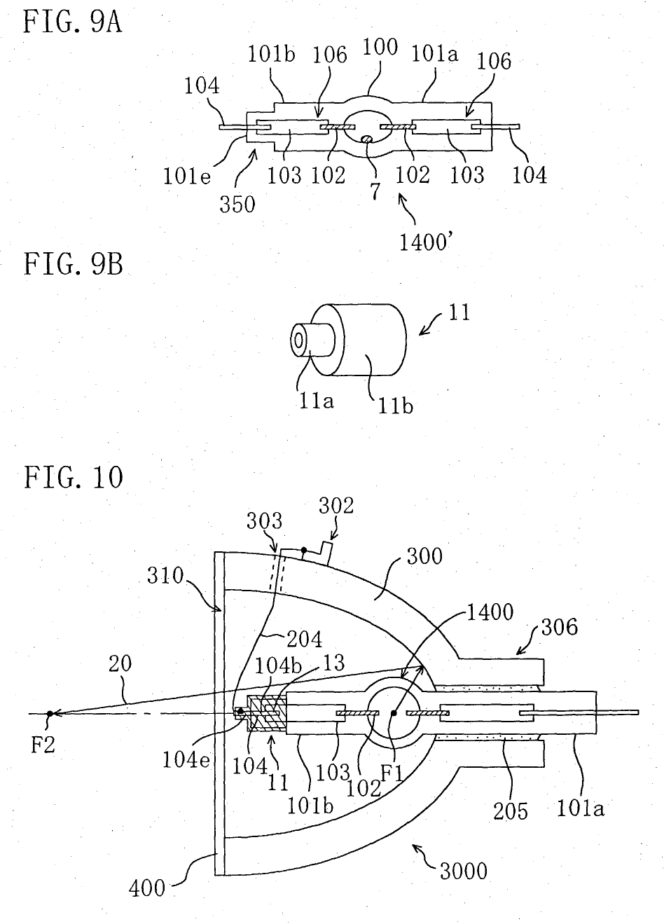

The high pressure discharge lamp 1300 shown in FIG. 8 can be modified to the structure shown in FIGS. 9A, 9B, and 10.

FIGS. 9A and 9B show a high pressure discharge lamp 1400′, which is a variation of this embodiment, and the front cap 11 to be attached to the tip thereof. Mercury 7, which is a luminous material, is shown in the luminous tube 100 in FIG. 9A. FIG. 10 schematically shows the structure of a lamp 3000 with a reflecting mirror including the high pressure discharge lamp 1400 in which the front cap 11 is attached to the lamp 1400′. A front glass 400 is attached to the wide opening 310 of the reflecting mirror 300 in the lamp 3000 with a reflecting mirror shown in FIG. 10. When the front glass 400 is attached, the reflecting mirror 300 has an airtight structure, so that even in an unlikely event that the lamp is broken, the broken pieces cannot be scattered outside.

The sealing portion 101b of the high pressure mercury lamp 1400 (1400′) has a shape in which the outer diameter of end portion 101e side is smaller than that of the luminous tube 100 side. That is to say, the sealing portion 101b has a portion in which the diameter is reduced (diameter-reduced portion or a cut-away portion) 350. A step is formed between the diameter-reduced portion 350 and the other portions by the difference in the diameter between them. More specifically, the high pressure mercury lamp 1400 (1400′) is a double end type discharge lamp produced with a glass tube including a luminous tube portion that will serve as the luminous tube and a first and a second side tube portions that will serve as the first and the second sealing portions having substantially the same outer diameter and extending from the luminous tube portion, the outer diameter of the second sealing is smaller than that of the first and the second side tube portion.

When the diameter-reduced portion 350 is formed in the sealing portion 101b in this manner and the front cap 11 is attached thereto, the outer circumference of the sealing portion 101b with the front cap 11 attached is not enlarged. Therefore, this is advantageous in that light 20 reflected by the reflecting mirror 300 and directed to the focal point F2 cannot be obstructed.

If the light 20 is reflected at a portion in the vicinity of the tip portion of the second sealing portion positioned on the wide opening 310 side, light that does not converge onto the focal point F2 is generated, which consequently causes the problem that brightness of the enlarged screen projected by the projector is reduced. Furthermore, when light falls on the vicinity of the tip portion of the second sealing portion, the temperature at that portion is increased. According to the structure shown in FIG. 10, the diameter-reduced portion 350 is formed in the sealing portion 101b, and the front cap 11 is attached thereto, so that the influence of the light 20 can be reduced and suppressed.

Here, instead of one step as shown in FIGS. 9A and 10, the diameter-reduced portion 350 can be configured as a tapered shape or a stair shape. The effect of not obstructing the light 20 directed to the focal point F2 can be obtained not only when the outer circumference of the front cap 11 is smaller than the outer circumference of the central portion (portion in which the diameter-reduced portion 350 is not formed) of the sealing portion 101b as shown in FIG. 10, but also when the outer circumference of the front cap 11 is substantially in flash with the outer circumference of the central portion of the sealing portion 101b. Furthermore, even if the outer circumference of the front cap 11 is slightly larger than the outer circumference of the central portion of the sealing portion 101b, the effect of not obstructing the light 20 can be obtained, compared with the case where there is no diameter-reduced portion 350. In view of obtaining the effect of not obstructing the light 20 directed to the focal point F2, not only in this embodiment, but also in the structures of Embodiments 1 and 2, the diameter-reduced portion 350 can be formed in the sealing portion 101b.

In the structure shown in FIG. 10, the front glass 400 is attached so that the reflecting mirror 300 has an airtight structure, and therefore the temperature tends to be increased during lamp operation. In such circumstances, operating a high pressure discharge lamp of 150 W or more means operation under very harsh conditions from the standpoint of the heat design of the current lamps.

When the external lead 104 made of molybdenum is subjected to welding, the molybdenum constituting the external lead 104 is oxidized and molybdenum oxide is produced. In the case of a lamp having a connection portion (see 104w of FIG. 18) by such welding, if the front glass 400 is attached to the reflecting mirror 300 as shown in FIG. 10, white “opaqueness” (that is, opaqueness due to molybdenum oxide) is generated in the front glass 400 near the welded portion (see 104w of FIG. 18) during operation. Such opaqueness is not preferable because the transmittance of the front glass 400 is reduced and the illuminance at the screen is decreased.

In the structure shown in FIG. 10, the external lead 104 is not welded but is caulked by the first portion 11a of the front cap 11, so that opaqueness due to molybdenum oxide as described above can be prevented. The front cap 11 can protect the base portion 104e and the buried portion 104b (preferably welded portion 13) of the external lead 104, and therefore the lamp can be operated stably under such harsh conditions.

The prevention of “opaqueness” of the front glass by the front cap is effective not only for a lamp having an airtight structure (lamp with a mirror), but also a lamp with a mirror in which a front glass is provided, and a cut-away portion also is provided in a portion of the mirror and air is convected through the cut-away portion. That is to say, in the case of a lamp with a mirror with a front glass, the effect of the opaqueness prevention by the front cap can be obtained by the front cap not only for the airtight type but also for non-airtight type having a cut-away.

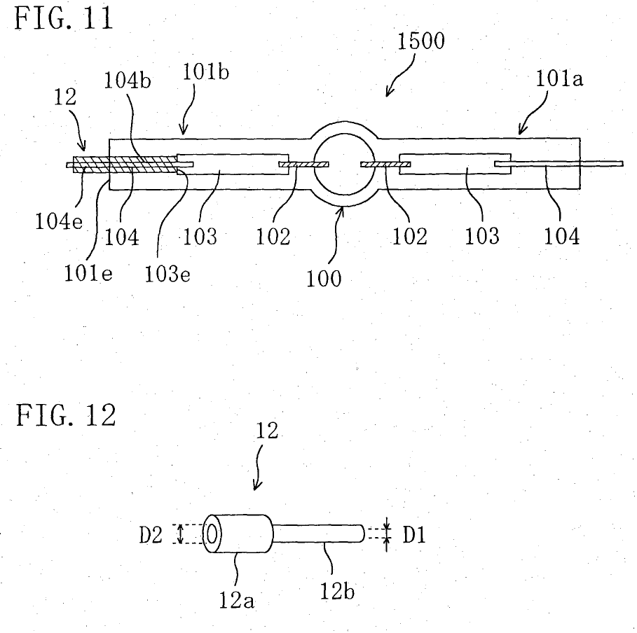

In order to protect the buried portion 104b of the external lead 104, the lamp can have the structure shown in FIG. 11. In the high pressure discharge lamp 1500 shown in FIG. 11, a front cap (cap portion) 12 that also covers a portion (104b) extending from the end face 103e of the metal foil 103 in the sealing portion 101b, in addition to the base portion 104e of the external lead exposed from the end face 101e of the second sealing portion 101b, is provided in the external lead 104. That is to say, the high pressure discharge lamp 1500 has a structure in which a portion of the front cap 12 is buried in a portion of the second sealing portion 101b. Furthermore, the temperature of the connection portion of the external lead 104 and the metal foil 103 in the structure in which the front cap 12 is buried in a portion of the second sealing portion 101b is lower than that in the structure in which the front cap 12 is not buried in a portion of the sealing portion 101b. This is because more heat can be conducted when the buried portion 104b of the external lead is covered with the front cap 12 than in the case of only the external lead 104, and the heat of the connection portion of the external lead 104 and the metal foil 103 can be released outside.

It is preferable to use the front cap 12 as shown in FIG. 12 in order to join the external lead 104 and the outward-drawn lead wire 204 by caulking in the tube in the tip portion of the front cap 12. That is to say, it is preferable to use a front cap 12 whose inner diameter D1 of the portion 12b to be buried in the sealing portion 101b is substantially equal to the wire diameter of the external lead 104, and whose inner diameter D2 of the top portion 12a in which the external lead 104 and the outward-drawn lead wire 204 are joined by caulking is slightly larger than the wire diameter of the two members (104 and 204).

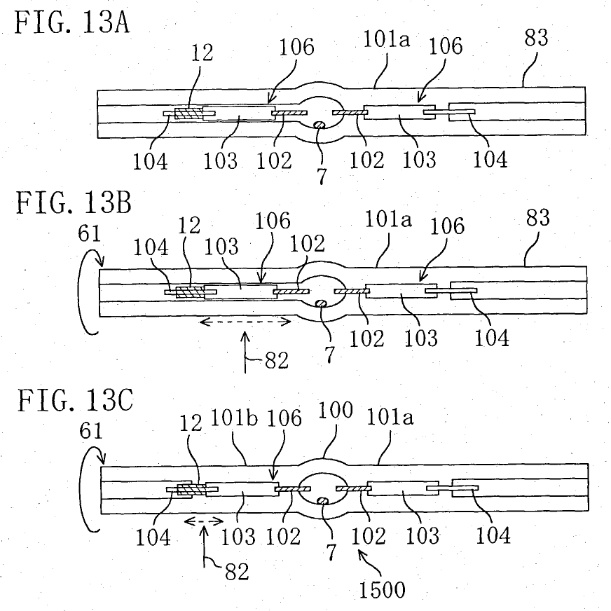

The high pressure discharge lamp 1500 can be produced in the manner shown in FIGS. 13A to 13C.

First, a glass tube 83 for a discharge lamp having a portion that will serve as the luminous tube and side tube portions is prepared. Then, an electrode assembly 106 including the electrodes 102, the metal foils 103 and the external leads 104 is inserted in one of the side tubes, and then a sealing portion forming process is performed to complete the sealing portion 101a. Then, as shown in FIG. 13A, the electrode assembly 106 in which the front cap 12 is inserted into the external lead 104 is inserted into the other side tube, and is positioned such that the electrodes 102 are spaced apart by a predetermined distance.

Next, as shown in FIG. 13B, the glass tube 83 is shrunk by heating a predetermined range with heating means (e.g., burner or laser) as shown in the arrow 82 while rotating the glass tube 83 in the direction shown by the arrow 61. At the time of the shrinking, the inside of the glass tube 83 is in a reduced pressure state.

Thereafter, as shown in FIG. 13C, the glass tube 83 in the portion in which the front cap 12 is positioned is also shrunk. Then, an unnecessary portion is removed, and thus the high pressure discharge lamp 1500 can be obtained. The processes for enclosing the mercury 7 and a rare gas and reducing the pressure can be performed in predetermined stages. Alternatively, the other sealing portion 101a may be formed after the sealing portion 104 in which the front cap 12 is formed.

An inorganic adhesive (e.g., cement) may be applied to the periphery of the front cap of the embodiments described above or on the light emission direction side thereof so as to reinforce the protection further. Furthermore, in the above-described embodiments, the cap portion (front cap) is provided in one sealing portion (101b), but the cap portion also can be provided in the other sealing portion (101a). This is because although it is more effective to provide the front cap in the sealing portion 101b positioned on the side in the light emission direction, it is importance to protect the external lead 104 in the sealing portion 101a on the opposite side.

Other Embodiments

In the above embodiments, high pressure mercury lamps have been described as an example of the lamp. However, this is an preferable example, and the lamp can be a xenon lamp or a metal halide lamp (including mercury-free metal halide lamps). Furthermore, in the above embodiments, high pressure mercury lamps having an amount of mercury enclosed of 150 mg/cm³ or more (so-called superhigh pressure mercury lamp) have been described, but the present invention can apply to high pressure mercury lamps having an amount of less than that. In the above embodiments, alternating current operation type lamps have been described, but the present invention is not limited thereto and can apply to an alternating current operation type and a direct current operation type. In addition, the distance (arc length) between the pair of electrodes 102 can be a distance of a short arc type (e.g., 2 mm or less) or can be longer than that.

An image projecting apparatus can be configured by combining the lamps with a reflecting mirror of the above embodiments and an optical system including an image device (DMD (Digital Micromirror Device) panels or liquid crystal panels). For example, a projector (digital light processing (DLP) projectors) using DMDs or liquid crystal projectors (including reflective projectors using a LCOS (Liquid Crystal on Silicon) structure) can be provided. Furthermore, the lamp with a reflecting mirror of the embodiments of the present invention can be used preferably, not only as a light source of an image projecting apparatus, but also for other applications, such as a light source for ultraviolet ray steppers or a light source for sport stadium, a light source for automobile headlights, and a floodlight for illuminating traffic signs.

The present invention has been described above by taking preferable embodiments as an example. The description is not limiting the present invention, and the present invention can be modified in many aspects.

According to the present invention, since the cap portion is provided in the base portion exposed from end face of the sealing portion of the external lead, a high pressure discharge lamp with a high wattage (e.g., 150 W or more) that is operated stably can be provided. In addition, the reliability for connection can be improved when the external lead and the outward-drawn lead wire are joined with the cap portion as a caulking member.

What is claimed is:

1. A high pressure discharge lamp comprising:
a luminous tube enclosing a luminous material in which a pair of electrodes are opposed; and
a pair of sealing portions for sealing metal foils electrically connected to the pair of electrodes, respectively,
wherein external leads are connected to the metal foils on a side opposite to the luminous tube side,
at least one of the external leads extends outward from an end face of the sealing portion,
a cap portion for covering the external lead is provided in a base portion of the external lead exposed from the end face of the sealing portion, and
the external lead is joined to an outward-drawn lead wire electrically connected to an external circuit by plastic flow of the cap portion, using the cap portion as a caulking member.

2. A high pressure discharge lamp comprising:
a luminous tube enclosing a luminous material in which a pair of electrodes are opposed; and
a pair of sealing portion for sealing metal foils electrically connected to the pair of electrodes, respectively,
wherein external leads are connected to the metal foils on a side opposite to the luminous tube side,
at least one of the external leads extends outward from an end face of the sealing portion, and
a cap portion for covering the external lead in a portion extending from an end face of the metal foil in the sealing portion, in addition to a base portion of the external lead exposed from the end face of the sealing portion, is provided in the external lead.

3. The high pressure discharge lamp according to claim 2,
wherein the external lead is joined to an outward-drawn lead wire electrically connected to an external circuit by plastic flow of the cap portion, using the cap portion as a caulking member.

4. The high pressure discharge lamp according to claim 1 or 2,
wherein mercury is enclosed in an amount of 150 mg/cm³ or more as the luminous material.

5. A lamp with a reflecting mirror comprising a high pressure discharge lamp and a reflecting mirror for reflecting light emitted from the high pressure discharge lamp,
wherein the high pressure discharge lamp is the high pressure discharge lamp according to claim 1 or 2,
the reflecting mirror has a reflecting surface that is substantially ellipsoidal, and
the high pressure discharge lamp is a high pressure discharge lamp to which a rated power of 150 W or more is supplied.

6. A lamp with a reflecting mirror comprising:
a double end type high pressure mercury lamp including a luminous tube enclosing a luminous material inside and a first and a second sealing portion extending from opposite ends of the luminous tube; and
a reflecting mirror for reflecting light emitted from the high pressure mercury lamp,
wherein the reflecting mirror includes a wide opening provided on a side in a light emission direction, and a narrow opening for fixing the high pressure mercury lamp,
the first sealing portion of the high pressure mercury lamp is fixed in a vicinity of the narrow opening of the reflecting mirror,
the second sealing portion of the high pressure mercury lamp is disposed on a side of the wide opening of the reflecting mirror,
the second sealing portion has a cap portion for covering at least a base portion of a external lead extending outward from the second sealing portion and being exposed,
the cap portion serves as a caulking member and is used to join the external lead and an outward-drawn lead wire by caulking, and
the external lead and the outward-drawn lead wire electrically connected to an external circuit are electrically connected each other, using the cap portion.

7. The lamp with a reflecting mirror according to claim 6,
wherein a maximum diameter of a reflecting surface of the reflecting mirror is 45 mm or less, and
the reflecting surface of the reflecting mirror is substantially ellipsoidal.

8. An image projecting apparatus comprising the lamp with a reflecting mirror according to claim 6 or 7 and an optical system using the lamp with a reflecting mirror as a light source.

9. The image projecting apparatus according to claim 8,
wherein the optical system has a digital micromirror device, and
the light source is of a type that converges outgoing light onto a focal point.
